(19) United States
(12) Patent Application Publication
(10) Pub. No.: US 2014/0061409 A1
(43) Pub. Date: Mar. 6, 2014

(54) MAGNETIC HANGER APPARATUS

(71) Applicant: DRUE MAYHEW, JR., Spokane, WA (US)

(72) Inventor: DRUE MAYHEW, JR., Spokane, WA (US)

(21) Appl. No.: 14/010,335

(22) Filed: Aug. 26, 2013

Related U.S. Application Data
(60) Provisional application No. 61/743,215, filed on Aug. 28, 2012.

(51) Int. Cl. F16M 13/02

(52) U.S. Cl. CPC F16M 13/02
USPC 248/206.5

(57) ABSTRACT

A magnetic hanger apparatus provides a first and second metallic member each defining a center hole for a fastener. A wedge receiver affixed to a first side portion of the first member defines a magnet cavity and a sector shaped slot. A wedge affixed to a first side portion of the second metallic member engages in the slot defined by the wedge receiver. A magnet is carried in the magnet cavity. The magnet's attractive forces positionally maintain the first member and the second member in adjacency with the wedge within the slot. The shape of the wedge and the thickness of the wedge receiver provide limited sliding relationship between the first metallic member and the second metallic member.

### RELATED APPLICATIONS

This Utility Patent Application claims the benefit of earlier filed U.S. Provisional Patent Application No. 61/743,215 filed on Aug. 28, 2012 and titled Magnetic Hanger Apparatus. The entire contents of the identified earlier filed U.S. Provisional Application is incorporated herein by this reference.

### BACKGROUND OF INVENTION

### 1. Field of Invention

This invention relates to hanger devices, and more particularly to a magnetic hanger apparatus using two metallic members, a magnet, a wedge and a wedge receiver to securely hang items such as picture frames on wall surfaces.

2. Background and Description of Prior Art

For ages, people have suspended items such as, but not limited to, picture frames from vertical surfaces, such as walls, with nails, screws and other devices that partially penetrate the wall surface, leaving a portion of the device extending outwardly from the wall surface upon which the item is suspended. When the picture frame has a large side-to-side dimension, it is common to attach a wire or similarly flexible strong element to a reverse side of the picture frame to extend from one side portion to an opposing side portion so that the wire may be looped over the device extending from the wall. In other instances, plural spaced apart fasteners may be used to secure the picture frame to the wall. In this latter instance, the mounting may be difficult because it is necessary to align and level both the fasteners on a reverse side of the picture frame as well as the mounting apparatus on the wall surface to which the picture frame is to be mounted. Such efforts can be cumbersome, time-consuming and difficult, especially when the picture frame or other item to be suspended is large or heavy. Frequently, such efforts result in multiple holes being drilled or otherwise formed in the wall surface which may lead to a need to repair the wall surface which is additional work and effort that is undesirable. This may be especially true in instances when nails or screws are being used to hang the item from the wall.

What is needed is an apparatus that allows a person to securely and accurately hang an item on a wall surface without the need to repeatedly place and remove the item, that allows easy and accurate leveling, that does not necessitate (or risk) multiple holes being formed in the wall, and a hanging system that is strong and secure so that there is minimal risk of the item falling from the wall.

My magnetic hanger apparatus overcomes various of the aforementioned drawbacks to known apparatus by providing a simple hanging apparatus that incorporates a magnet between two metallic members, a wedge and a wedge receiver defining a wedge receiving slot. The wedge, and the wedge receiver provide vertical support to the item being suspended from the wall surface, and the magnet provides attractive forces that positionally maintain of the wedge in engagement with the wedge receiving slot.

My magnetic hanger apparatus is fastenable to a reverse side of the item being suspended from a wall. By means of adhesive pads, portions of my magnetic hanger apparatus may be fastened to a wall surface in a correct spacing, leveling and orientation for the hanging of the item eliminating the need to adjust the placement of the hangers after holes have been formed in the wall.

Some or all of the drawbacks and problems explained above, and other known drawbacks and problems, may be helped or solved by my invention shown and described herein. My invention may also be used to address other problems not set out herein or which become apparent at a later time. The future may also bring to light unknown benefits which may, in the future, be appreciated from the novel invention shown and described herein.

My invention does not reside in any one of the identified features individually, but rather in the synergistic combination of all of its structures, which give rise to the functions necessarily flowing therefrom as hereinafter specified and claimed.

### SUMMARY

A magnetic hanger apparatus provides a first metallic member and a second metallic member each defining a center hole having a chamfered circumferential edge thereabout for flushly carrying a threaded fastener extending therethrough. A wedge receiver affixed to a first side portion of the first metallic member is partially circular with a thickness and defines a central cavity and a radially aligned sector shaped wedge receiving slot. A wedge affixed to a first side portion of the second metallic member has a thickness and defines an outer circumferential arc and an inner arc so that when engaged with the wedge receiver the wedge and wedge receiver form “doughnut” shape having a circular outer circumference and defining a circular center magnet cavity. A magnet having a thickness similar to the thickness of the wedge receiver and the wedge is carried in the magnet cavity. The magnet's attractive forces positionally maintain the first metallic member and the second metallic member in adjacency with the wedge within the sector shaped slot. The shapes and thicknesses of the wedge and the wedge receiver provide limited sliding relationship between the first metallic member and the second metallic member.

In providing such magnetic hanger apparatus it is:

a principal object to provide a hanger apparatus that uses magnetic forces.

a further object to provide such a hanger apparatus that provides secure positional maintenance.

a further object to provide such a hanger apparatus that allows easy mounting and leveling of wall hangings.

a further object to provide such a hanger apparatus that uses magnets to supply attractive forces and a wedge within a wedge receiver slot to limit frictional sliding movement.

a further object to provide such a hanger apparatus that allows a single person to hang and level large items on walls.

a further object to provide such a hanger apparatus that allows wall hangings to be mounted flushly to a wall.

a still further object to provide such a hanger apparatus that can be inexpensively and the easily manufactured using commonly available materials.

Other and further objects of my invention will appear from the following specification and accompanying drawings which form a part hereof. In carrying out the objects of my invention it is to be understood that its structures and features and steps are susceptible to change in design and arrangement and order with only one preferred and practical embodiment of the best known mode being illustrated in the accompanying drawings and specified as is required.

### BRIEF DESCRIPTIONS OF DRAWINGS

Specific forms, configurations, embodiments and/or diagrams relating to and helping to describe preferred versions of my invention are explained and characterized herein, often with reference to the accompanying drawings. The drawings and all features shown therein also serve as part of the disclosure of my invention, whether described in text or merely by graphical disclosure alone. Such drawings are briefly described below.

FIG. 1 is an isometric first side view of the second member showing the wedge thereon, the center hole and the chamfered edge about the center hole.

FIG. 2 is an isometric side view of the magnet.

FIG. 3 is an isometric first side view of the first member and the wedge receiver thereon defining the sector shaped wedge receiver slot, the magnet cavity and the chamfered edge about the center hole.

FIG. 4 is an isometric second side view of the first member showing the adhesive pad thereon.

FIG. 5 is an isometric first side view of the first member, similar to that of FIG. 3 showing the magnet within the magnet cavity.

FIG. 6 is an orthographic second side view of the second member.

FIG. 7 is an orthographic side view of a threaded fastener.

FIG. 8 is an orthographic side view of the wedge receiver and wedge spaced apart radially from the sector shaped slot defined by the wedge receiver.

FIG. 9 is an orthographic second side view of the first member and a partial view of the first side of the second member partially slidably disengaged from one another so that the sector shaped wedge carried on the second member is visible.

FIG. 10 is an orthographic edge view of the first member and second member disengaged from one another.

FIG. 11 is an orthographic edge view of the first member and second member vertically slidably engaged with one another.

FIG. 12 is an orthographic rear view of a picture frame carrying two second members in spaced apart relation.

FIG. 13 is an orthographic edge view similar to that of FIG. 10 showing the first member mounted to a vertical wall surface and the second member mounted to a picture frame.

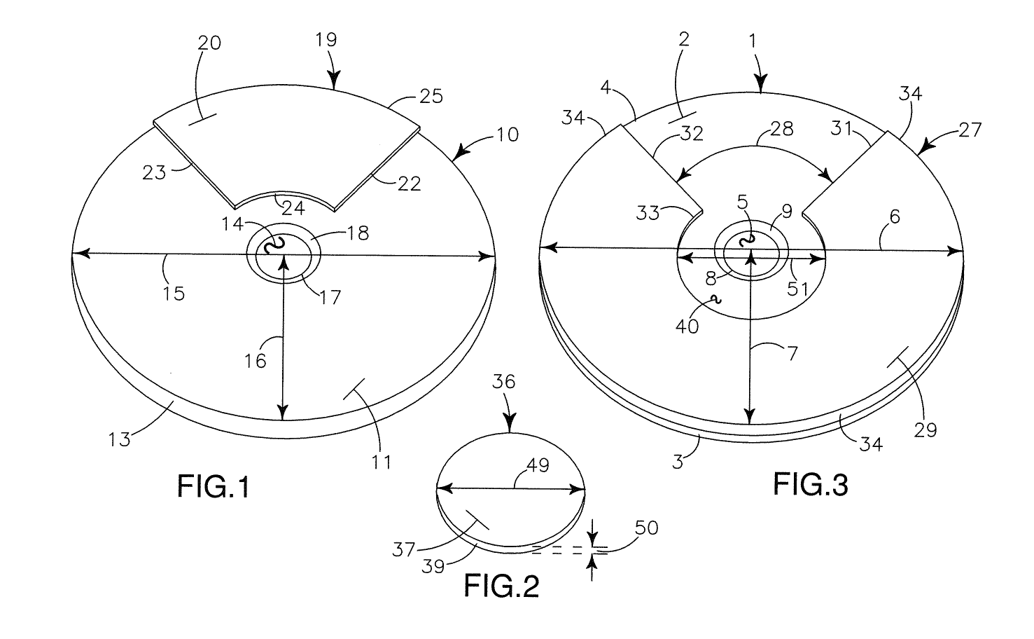

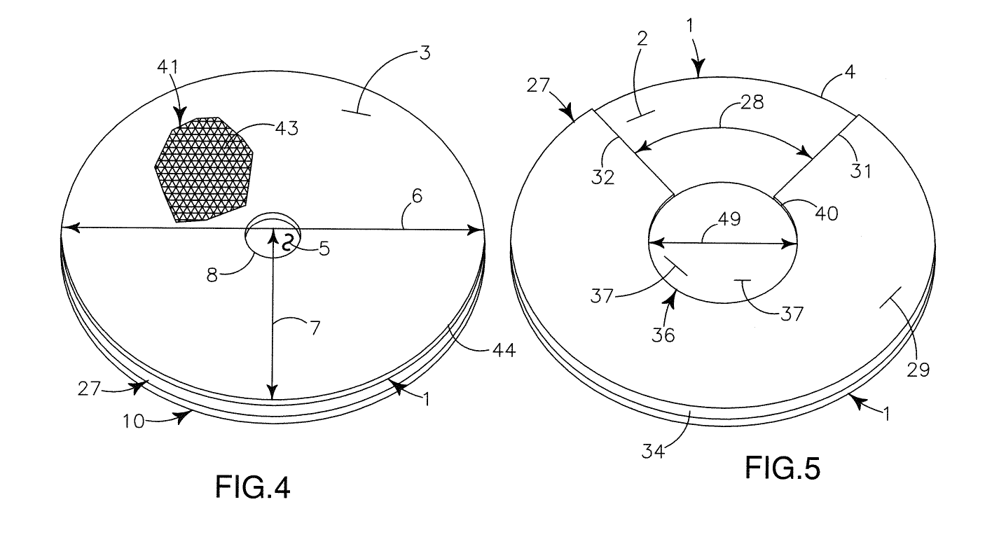

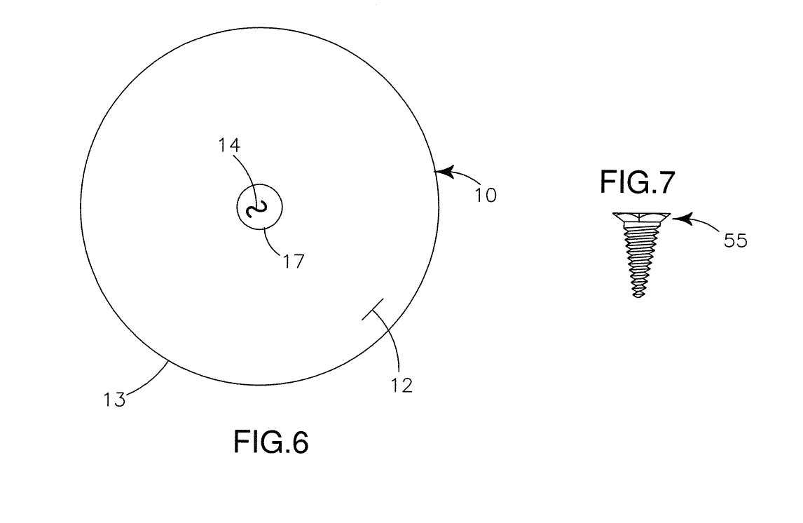

### DESCRIPTION OF PREFERRED EMBODIMENT

The readers of this document should understand that the embodiments described herein may rely on terminology used in any section of this document and other terms readily apparent from the drawings and the language common therefore as may be known in a particular art and known or indicated or provided by dictionaries. Dictionaries were used in the preparation of this document. Widely known and used in the preparation hereof are Webster's Third New International Dictionary (©1993), The Oxford English Dictionary (Second Edition, ©1989), The New Century Dictionary (©2001-2005) and the American Heritage Dictionary of the English Language (4^{th} Edition ©2000) all of which are hereby incorporated by this reference for interpretation of terms used herein to more adequately or aptly describe various features, aspects and concepts shown or otherwise described herein.

This document is premised upon using one or more terms or features shown in one embodiment that may also apply to or be combined with other embodiments for similar structures, functions, features and aspects of the invention. Wording used in the claims is also descriptive of the invention and the text of both the claims and the abstract are incorporated by reference into the description entirely.

Although my magnetic hanger apparatus may be used on any of a variety of wall hangings, including, but not limited to picture frames, pictures, photographs, paintings, mirrors and decorative wall hangings, it will be described herein in the context of use with a picture frame 60.

A typical embodiment of a picture frame 60 has a generally rectilinear configuration with two pairs of parallel spaced apart frame members, namely an upper member 61 and a lower member (not shown) and first and second parallel spaced apart side portions 62, 63. The frame members 61, 62 and 63 are interconnected by known means at adjoining end portions at right angles to form a peripheral configuration defining a central orifice that typically is filled with a picture, a photograph or painting. Commonly the picture frame 60 is decorative in nature on forward/front outward facing surfaces adjacent to the picture. The reverse sides of the frame members 61, 62 and 63 are typically unadorned and means for hanging the picture frame 60, as well as means for securing a picture within the frame 60 are located on the reverse side. Commonly, picture hanging apparatus, such as saw-tooth picture brackets (not shown) are centered and carried on the reverse side of the upper frame member 61 for releasable engagement with a nail, stud or other rigid element (not shown) extending outwardly from a wall surface 65 upon which the saw-tooth frame bracket (not shown) may engage with and positionally rest upon. Saw-tooth brackets (not shown) are common because they allow some amount of lateral adjustment (side to side) of a picture frame 60 to allow balancing of the picture frame 60 upon the nail/stud (not shown) so that the picture frame 60 may be leveled.

Another known means for hanging a picture frame 60 from a wall is a wire (not shown) strung between the two spaced apart side frame members 62, 63, and the wire is looped over the nail, stud or other rigid element extending outwardly from the wall surface 65.

My magnetic hanger apparatus generally provides a first member 1, a second member 10 and a magnet 36. Known threaded fasteners 55 may be inserted into and extend through center holes 6, 14 defined in the first member 1 and the second member 10 respectively to positionally secure the second member 10 to a reverse side of a picture frame 60 and the first member 1 to a wall surface 65.

The first member 1 is formed of a ferrous material such as, but not limited to iron or steel so that it has magnetic attractiveness. The first member 1 has a first surface 2, an opposing second surface 3, an outer circumferential edge 4, a diameter 6, a radius 7 and defines a center hole 5 having a chamfered 9 edge extending thereabout.

A wedge receiver 27 is permanently affixed to the first surface 2 of the first member 1 such as with adhesive. The wedge receiver 27 has a thickness 35, a generally planar first surface 29, an opposing second surface (not shown) and defines a sector shaped slot 28 and a centered magnet cavity 40. The sector shaped slot 27 has a first leg 31 and a spaced apart second leg 32 that communicate from an outer circumferential edge 34 to a center arc 33 that extends about the centered magnet cavity 40. In the preferred embodiment, the wedge receiver 27 is generally circular and the first leg 31 and the second leg 32 are aligned radially with a center (not shown) and extend at right angles (90°) from one another. In the preferred embodiment, the second surface (not shown) of the wedge receiver 27 is immediately adjacent the first surface 2 of the first member 1, and is permanently affixed thereto with a known adhesive, such as, but not limited to Super-Glue® or Epoxy®. The magnet cavity 40 is centered over the center hole 5 defined in the first member 1 and the chamfer 9 is within the magnet cavity 40.

The second member 10 is similarly formed of a ferrous material such as, but not limited to iron or steel so that it has magnetic attractiveness. The second member 10 has a first surface 11, a second surface 12, an outer circumferential edge 13, a diameter 15, a radius 16 and defines a center hole 14 having a chamfered edge 18 extending thereabout.

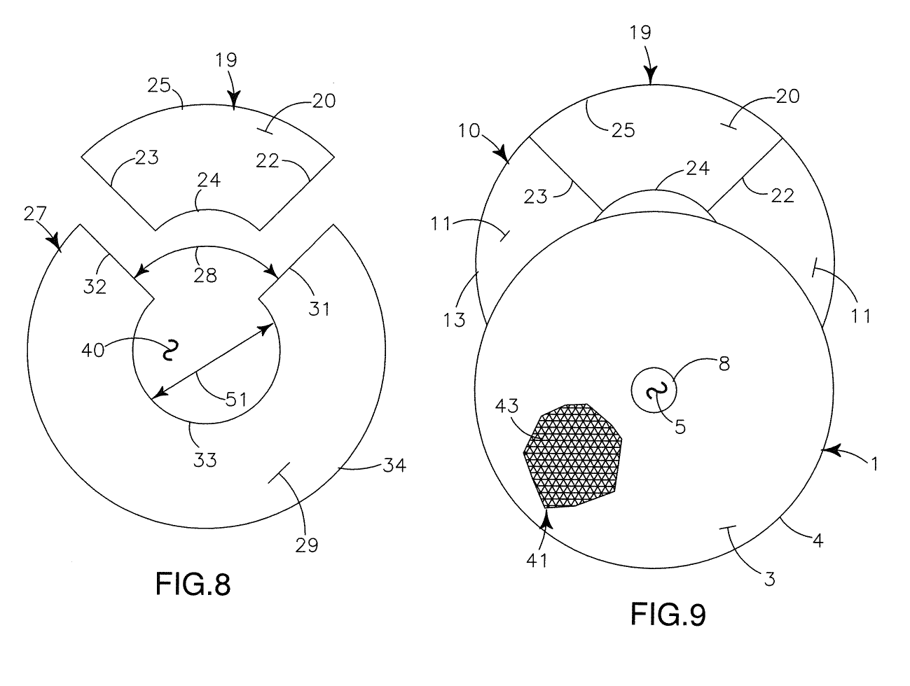

A wedge 19 is permanently affixed to the first surface 11 of the second member 10, such as with adhesive. The wedge 19 has a thickness 26, a generally planar first surface 20, an opposing second surface (not shown) and peripherally defines a shape of a sector that is the same as the sector shaped slot 28 defined in the wedge receiver 27 so that when the wedge 19 is engaged with the wedge receiver 27, the two interconnected pieces, 19, 27 form of a circle defining a circular magnet cavity 40. (See FIG. 8).

The wedge 19 has a first leg 22 and a second leg 23 that communicate from an outer circumferential arc edge 25 to an inner arc 24 that forms a portion of the magnet cavity 40. In the preferred embodiment, the first leg 22 and the second leg 23 extend at right angles (90°) from one another. In the preferred embodiment, the second surface (not shown) of the wedge 19 is immediately adjacent the first surface 11 of the second member 10, and is permanently affixed thereto with a known adhesive, such as, but not limited to Super-Glue® or Epoxy®.

In the preferred embodiment, the wedge 19 and the wedge receiver 27 are formed from a nylon washer (not shown) having diameter (not shown) similar to the diameters 6, 15 of the first member 1 and the second member 10 respectively. The wedge 19 is preferably formed by cutting a 90° sector shaped portion from a nylon washer (not shown) so that the removed piece (not shown) forms the wedge 19 and the remaining portion of the nylon washer (not shown) defining 90° slot formed therein, forms the wedge receiver 27. (FIG. 8).

A magnet 36, which is preferably a neodymium magnet, has a thickness 50, a first surface 37, a second surface (not shown) an outer circumferential edge 39 extending thereabout and a diameter 49. As shown in FIG. 5, the magnet 36 is releasably carried within the magnet cavity 40 and the diameter 49 of the magnet 36 is equal to, or slightly less than diameter 51 of the magnet cavity 40. Because the wedge receiver 27 center arc 33 extends through a 270° arc forming more than half the magnet cavity 40, the magnet 36 is positionally maintained within the magnet cavity 40 and is not dislodged from the magnet cavity 40 by frictional sliding movement of the second member 10 thereover.

As shown in FIG. 8, the wedge 19 “fits into” the slot 28 defined in the wedge receiver 27. The angles of the first legs 22, 31 and the second legs 23, 32, which are radial provide that the wedge 19 may only be disengaged from the slot 28 by moving the wedge 19 radially away from the wedge receiver 27, or by “lifting” the wedge 19 from the slot 2 perpendicular to the first surfaces 2, 11 of the members 1, 10 respectively. The magnetic attraction of the magnet 36 causes the first member 1 carrying the wedge receiver 27 and the second member 10 carrying the wedge 19 to resist being “pulled apart” in any direction other than frictional sliding of the members 1, 10 along one another. Because the wedge 19 can only be disengaged from the slot 28 by sliding the wedge 19 radially away from the center hole 5 defined in the first member 1, the thickness 26, 35 of the wedge 19 and wedge receiver 27, respectively, and the shape of the wedge 19 relative to the slot 28 prevents the wedge 19 from moving relative to the wedge receiver 27 in any direction other than radially away from a center of the wedge receiver 27.

An adhesive pad 41 having an outer peripheral configuration similar to that of the first member 1 is carried on the second surface 3 of the first member 1 to aid in the mounting of a picture frame 60 to a wall surface 65. The adhesive pad 41 has a first surface (not shown) that is preferably adhesively attached to the second surface 3 of the first member 1 and an opposing second surface 43 opposite the first member 1 which has a “sticky” adhesive surface 45 that may be covered with a removable surface covering (not shown) that is removed for use. The adhesive pad 41 allows for temporary securement of the first member 1 to a wall surface 65 in proper alignment and leveling. The adhesive pad 41 positionally maintain the first member 1 and the wedge receiver 27 thereon to the wall surface 65 so that threaded fasteners 55 may be inserted through the center hole 5 to securely affix the first member 1 to the wall surface 65.

The first member 1 carrying the wedge receiver 27 is preferably mounted so that the slot 28 opens vertically upwardly (FIG. 3) so that the second member 10 carrying the wedge 19 may vertically engage with the slot 28 of the wedge receiver 27. (FIG. 8). The magnetic attraction provided by the magnet 36 tends to prevent “pulling apart”/“extensive” movement of the members 1, 10 relative to one another, but allows sliding movement of the members 1, 10 relative to one another. The wedge 19 and the wedge receiver 27 limit the sliding movement to one direction, namely radially away from a center of the wedge receiver 27. The first member 1 and the second member 10 may also both be rotated 180 degrees to achieve the same effect with the slot 28 opening downwardly (not shown) and the wedge 19 pointed upwardly (not shown).

In the preferred embodiment, the first member 1 and the second member 10 have a diameter of approximately 1.25 inches and define center holes 5, 14 having a diameter of approximately 0.25 inches. The wedge 19 and wedge receiver 27 are preferably formed of the nylon washer having a diameter of approximately 1.25 inches and defining a center hole (not shown) having a diameter of approximately 0.50 inches. The thickness 26, 35 of the nylon washer (not shown) is preferably approximately 0.0625 inches. It is to be understood however that even though the preferred diameters and thickness of the members 1, 10 and wedge 19 and wedge receiver 27 are disclosed herein, other sizes and a diameters and thicknesses are anticipated and contemplated and may similarly be used.

Having described the structure of my magnetic hanger apparatus, its operation may be understood.

A nylon washer (not shown) having an outer circumferential edge (not shown) and defining a center hole (not shown) is cut along radial lines by known means with a known tool so that a 90° sector shaped wedge is removed from the nylon washer. The cutting of the nylon washer (not shown) creates two pieces, namely the wedge 19 and the wedge receiver 27.

A member 1, 10 which is formed of a ferrous material, such as, but not limited to iron or steel and may be a commercially available washer is modified with a known tool to form chamfer 9, 18 on an edge portion extending about the center hole 5, 14 so that a threaded fastener 55 may “seat” flushly within the center hole 5, 14 of the member 1, 10.

The wedge receiver 27 is affixed, with a known adhesive such as Super-Glue® or Epoxy® to the first member 1 so that the first surface 2 of the first member 1 is immediately adjacent the second surface (not shown) of the wedge receiver 27. The wedge receiver 27 is aligned on the first surface 2 of the first member 1 so that the center hole 5 of the first member 1 is centered in the magnet cavity 40 defined in the wedge receiver 27.

The wedge 19 is affixed, with a known adhesive such as Super-Glue® or Epoxy® to the second member 10 so that the first surface 11 of the second member 10 is positioned immediately adjacent the second surface (not shown) of the wedge 19. The wedge 19 is aligned on the first surface 11 of the second member 10 so that the center hole 14 of the second member 10 is centered within the inner circumferential arc 24 of the wedge 19.

An adhesive pad 41 is affixed to the second surface 3 of the first member 1. The removable surface covering (not shown) of the adhesive pad 41 opposite the first member 1 is left in place until use of the hanging apparatus.

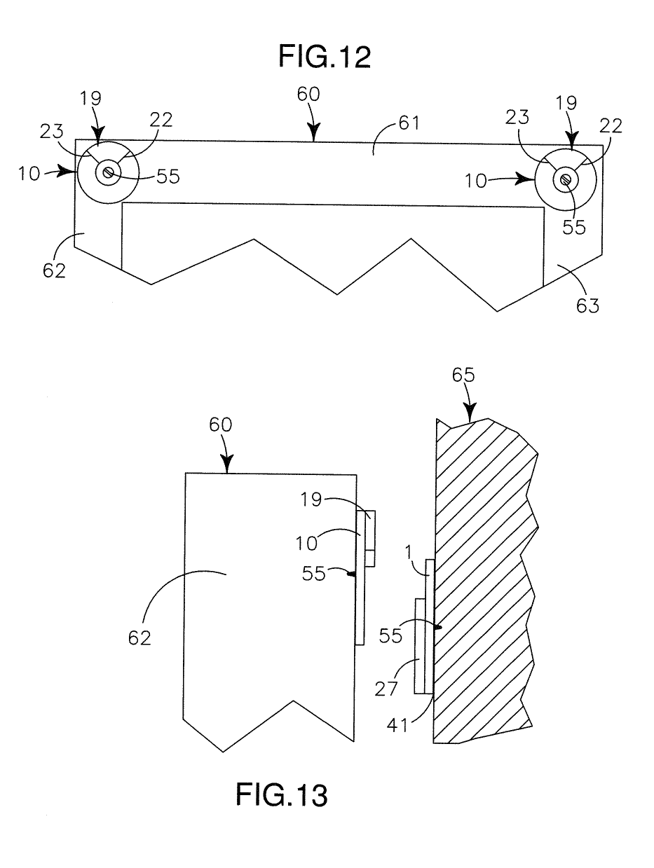

A picture frame 60 is positioned so that its reverse side is upward facing and accessible to a user. The user places at least one second member 10 on the reverse side of the picture frame 60 in spaced apart array so that the picture frame 60 may be suspended therefrom with the second surfaces (not shown) of the second members 10 immediately adjacent to the reverse side of the picture frame 60. A threaded fastener 55, such as a screw preferably having a tapered head portion is inserted into the center hole 14 defined in the second member 10 and is engaged with the picture frame 60 to securely affix the second member 10 to the picture frame 60. Before the fasteners 55 are “tightened” the second member 10 is rotated about the fastener 55 so that the wedge 19 is proximate a top portion of the picture frame 60 with the outer circumferential arc 25 of the wedge 19 proximate an upper edge of the picture frame 60 and the inner circumferential arc 24 of the wedge 19 distal from the upper edge of the picture frame 60. (FIG. 12). Once the second member 10 has been so aligned, the fastener 55 is securely tightened so that the second member 10 may not rotate relative to the fastener 55. The process is repeated for mounting any remaining second members 10 to the picture frame 60.

The magnet 36 is placed in the magnet cavity 40 defined by the wedge receiver 27 carried by the first member 1. Thereafter, the first member 1 is engaged with the second member 10 so that the wedge 19 is within the slot 28 and the magnet 36 positionally maintains the first member 1 relative to the second member 10. The first member 1 should be slidably moved relative to the second member 10 so that the wedge 19 is fully engaged with the slot 28 and further/additional radial sliding movement is prevented by the shape of the wedge 19 and the slot 28.

The adhesive surface covering (not shown) is removed from the adhesive pad 41 on the second surface 3 of the first members 1.

The picture frame 60 is positioned at the position it is to be mounted, and is leveled, such as by placing a “bubble level” (not shown) on an upper member 61 of the picture frame 60. Once the picture frame 60 is in the correct position, and is leveled, the user presses the picture frame 60 securely against the wall surface 65 and ensures that the adhesive pads 41 on the first members 1 are in direct frictional contact with the wall surface 65. Thereafter, the user slides the picture frame 60 vertically upwardly along the wall surface 65. The sliding movement of the picture frame 60 will cause the first members 1 which are adhesively affixed to the wall surface 65 by the adhesive pads 41 to slidably disengage from the second members 10 affixed to the rear side of the picture frame 60 with threaded fasteners 55. Disengagement of the first members 1 from the second members 10 allows the picture frame 60 to be removed from the wall 65 and reveals that the first members 1 remain adhesively affixed to the wall surface 65 at the desired locations.

The user removes the magnet 36 from the magnet cavity 40, such as with a screwdriver or other known tool that allows the user to “pry” the magnet 36 from the magnet cavity 40. Thereafter, the user inserts a fastener 55 through the center hole 5 defined in the first member 1 to affix the first member 1 to the wall surface 65. Alternatively, the user may, if desired, use a pen or other type of marking device to mark the location of the center hole 5 defined in the first member 1. The user may then form a hole (not shown) in the wall 65 by known means and inserts a known drywall fastener, or the like, into the hole (not shown). Thereafter, the user may reposition the first member 1 and insert a fastener 55 through the center hole 5 to affix the first member 1 to the wall 65 at the desired location. The user must insure that the first member 1 is rotated/positioned such that the slot 28 opens upwardly and forms a “V” into which the wedge 19 may engage, (FIG. 8). The process is repeated for mounting the remaining first members 1 to the wall surface (not shown).

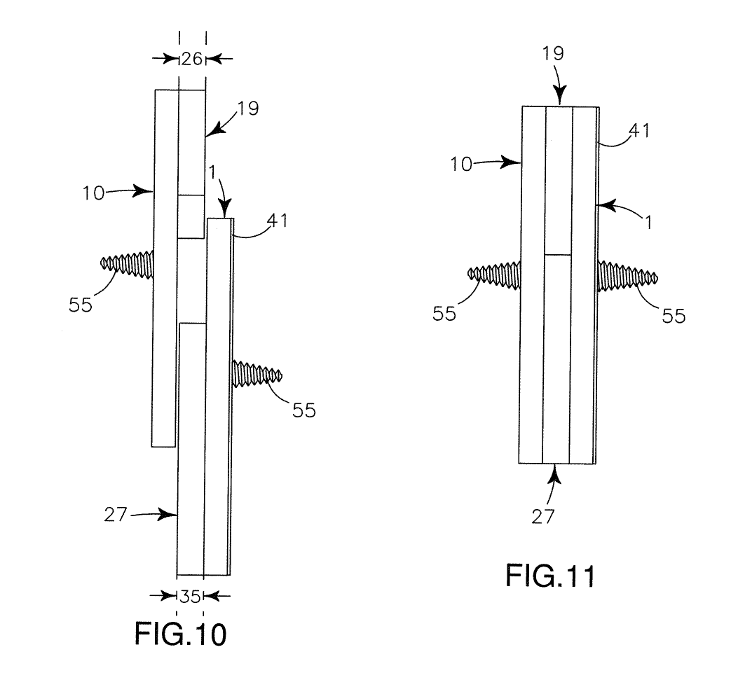

After the first members 1 have been secured to the wall, magnet 36 is replaced in the magnetic cavity 40. Thereafter, the picture frame 60 is positioned adjacent above the mounted first members 1 (FIG. 10) and is “slid” vertically downwardly along the wall surface until the wedges 19 of the second members 10 engage with the slots 28. (FIG. 11). The magnet 36 retains the picture frame adjacent the wall surface 65 and the engagement of the wedges 19 in the wedge receiver slots 28 prevents the picture frame from moving vertically downwardly along the wall surface.

The foregoing description of my invention is necessarily of a detailed nature so that a specific embodiment of a best mode may be set forth as is required, but it is to be understood that various modifications of details, sizes, and rearrangement, substitution and multiplication of the parts may be resorted to without departing from its spirit, essence or scope.

Having thusly described my invention, I file this Utility Patent Application and Pray Issuance of UTILITY LETTERS PATENT.

1. A hanger apparatus comprising in combination:
a first member of a ferrous material having a first side portion and defining a through hole;
a wedge receiver carried on the first side of the first member, the wedge receiver having a thickness and defining a wedge receiving slot and defining a magnet cavity;
a second member of a ferrous material having a first side portion and defining a through hole;
a wedge carried on the first side of the second member, the wedge having a thickness and a peripheral shape that fits into the wedge receiving slot;
a magnet carried within the magnet cavity; and
a fastener carried in the through hole to releasably secure the member to a surface.

2. A magnetic hanger apparatus comprising in combination:
a first metallic member having a first side, a second side, a circumferential edge and defining a center hole;
a second metallic member having a first side, a second side, a circumferential edge and defining a center hole;
a wedge receiver carried on the first side of the first member, the wedge receiver defining slot having a first leg and a spaced apart second leg, both legs extending from an outer circumferential edge to a magnet cavity defined in a center portion of the wedge receiver;
a wedge carried on the first side of the second member for releasable engagement with the slot defined in the wedge receiver;
a magnet carried in the magnet cavity to cause the first member and the second member to be magnetically attracted to one another and to resist separation from one another; and
a fastener extending through center hole defined in the first member and the second member to affix the first member and the second member to a wall surface and a wall hanging.

3. The hanger apparatus of claim 1 wherein: the first member and the second member are washers.

4. The hanger apparatus of claim 1 wherein: the magnet cavity is circular.

5. The hanger apparatus of claim 1 wherein: the wedge receiving slot defines an arc of less than 180 degrees.

6. The hanger apparatus of claim 1 wherein: the wedge receiving slot defines an arc of 90 degrees.

7. The hanger apparatus of claim 1 further comprising:
an adhesive carried on a side portion of the first member opposite the wedge receiver.

8. The hanger apparatus of claim 1 further comprising:
an adhesive carried on a side portion of the second member opposite the wedge.

9. The hanger apparatus of claim 1 wherein:
the thickness of the wedge receiver and the thickness of the wedge are the same.

10. The hanger apparatus of claim 1 further comprising:
chamfered edges around the through hole defined by the first member and the second member.

11. The hanger apparatus of claim 1 wherein: the fastener has a tapered head to set flushly within the through hole.
